(19) United States
(12) Patent Application Publication
(10) Pub. No.: US 2007/0186588 A1
(43) Pub. Date: Aug. 16, 2007

(54) Foil-shaping press

(75) Inventors: Jorg Knuppel, Schwendi (DE); Jurgen Matzenmuller, Bellamont (DE); Harald Litke, Achstetten (DE)

Correspondence Address: K.F. ROSS P.C., 5683 RIVERDALE AVENUE, SUITE 203 BOX 900, BRONX, NY, 10471-0900, US

(73) Assignee: UHLMANN Pac-Systeme GmbH & Co. KG

(21) Appl. No.: 11/705,806

(22) Filed: Feb. 13, 2007

(30) Foreign Application Priority Data
Feb. 15, 2006 (DE) 102006007205.7

(51) Int. Cl. C03B 23/02

(52) U.S. Cl. 65/287

(57) ABSTRACT

A press for shaping a workpiece sheet. The press has upper and lower platen holders displaceable vertically toward and away from each other between a closed and an open position, respective upper and lower platens carried on the holders and vertically flanking the workpiece sheet extending horizontally between them, a hold-down plate on one of the platens and having a substantially planar face turned toward the other platen, and a plurality of bars on the other platen having edges directly engageable with the planar face of the hold-down plate.

### FIELD OF THE INVENTION

The present invention relates to a foil-shaping press. More particularly this invention concerns such a press that presses an array of pockets into a basically planar plastic or metal foil.

### BACKGROUND OF THE INVENTION

The invention relates to a shaping station for shaping film, particularly plastic or metal film, in particular in a packaging machine, comprising an upper tool holder for an upper platen or shaping tool and a lower tool holder for a lower platen or shaping tool. The sheet workpiece, normally a foil, is guided between the upper shaping tool and the lower shaping tool. One of the tools has a hold-down device and the other tool has a support face.

Shaping stations of this type are known from practice, with corrugated strips made of steel provided on the hold-down device and optionally also on the support face. These strips have very low tolerance compensation and therefore must be aligned with a tolerance of 0.02 mm. They are complex to produce, are subject to wear and tear and due to the required high-precision alignment are expensive to manufacture.

### OBJECTS OF THE INVENTION

It is therefore an object of the present invention to provide an improved foil-shaping press.

Another object is the provision of such an improved foil-shaping press that overcomes the above-given disadvantages, in particular that is which is of simple and inexpensive construction, yet which works as well as the prior-art presses for example in forming an array of pockets in a sheet workpiece.

### SUMMARY OF THE INVENTION

A press for shaping a workpiece sheet. The press has according to the invention upper and lower platen holders displaceable vertically toward and away from each other between a closed and an open position, respective upper and lower platens carried on the holders and vertically flanking the workpiece sheet extending horizontally between them, a hold-down plate on one of the platens and having a substantially planar face turned toward the other platen, and a plurality of bars on the other platen having edges directly engageable with the planar face of the hold-down plate.

With the instant invention the simple planar clamping face of the hold-down device that is dimensioned sufficiently large, is used for achieving the desired clamping effect of the foil between the upper shaping tool and the lower shaping tool. This clamping effect is supported in that the clamping face is provided with a hard coating on the clamping face that has previously been prepared by means of glass bead blasting. These characteristics guarantee very good surface properties, which through the use of simple means produces high clamping forces and thus securely clamps the foil without deforming or damaging the Clamped part of the foil. As a result, less waste is produced, particularly also since the clamping face can have smaller dimensions due to its surface-properties.

So as to achieve a long service life of the coating, it is advantageous-if the coating is a ceramic, preferably one having low roughness of 2.7 micrometers. This low roughness in turn serves to prevent the clamping face from biting into the foil.

Furthermore according to the invention it is particularly preferable if the clamping bars are made of plastic since plastic brings about increased static friction in relation to the foil and at the same time provides tolerance compensation through elastic deformation as a result of the modulus of elasticity inherently found in plastics.

In practice, it has proven useful to make the upper and/or the lower platen or shaping tool from aluminum, particularly because relatively low weight can be achieved despite the use of metal. Furthermore, it has proven useful if the upper shaping tool comprises at least one punch and the lower shaping tool comprises at least one complementary seats or recess so that the upper tool acts as a male unit and the lower shaping tool as a female unit.

Pressure is applied to the hold-down plate by a compression spring supported on the upper platen. Thus a minimum amount of clamping force acting on the foil when placed on top is guaranteed in the open position of the shaping tools.

Furthermore, according to the invention the clamping bars are attached crosswise to the clamping direction on the associated shaping tool in order to achieve uniform clamping in all locations.

It is emphasized that the tool holders are associated with actuators and guides for aligning the lower shaping tool relative to the upper shaping tool to allow the lower shaping tool and the upper shaping tool to be produced from separate tool parts that require no guidance relative to each other.

### BRIEF DESCRIPTION OF THE DRAWING

The above and other objects, features, and advantages will become more readily apparent from the following description, reference being made to the accompanying drawing in which:

FIG. 1 is a small-scale partly schematic side view of a press according to the invention;

FIG. 2 is a larger-scale vertical section through the platens of the inventive press; and

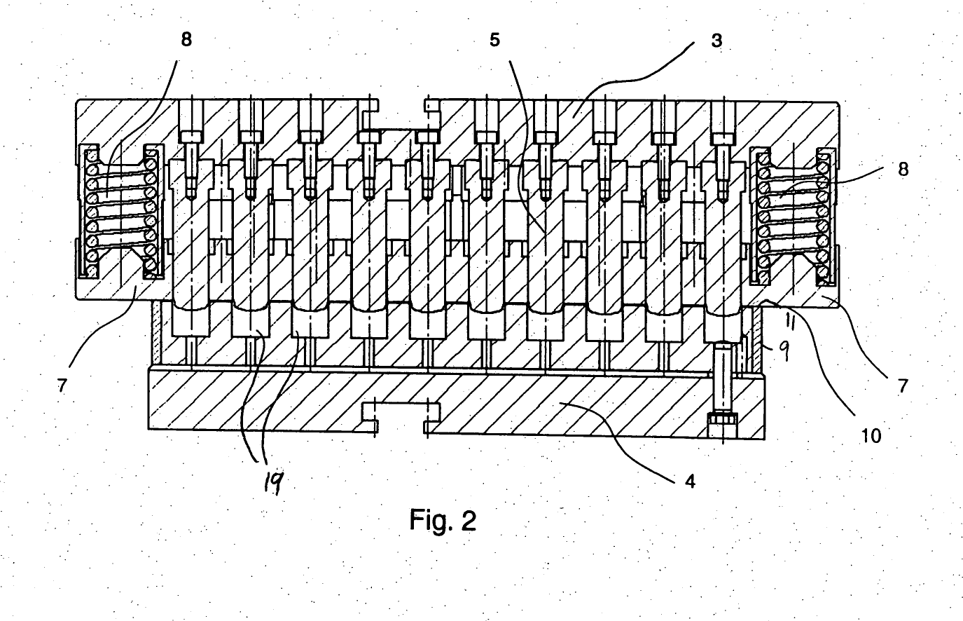

FIG. 3 is a perspective view from above of the lower platen.

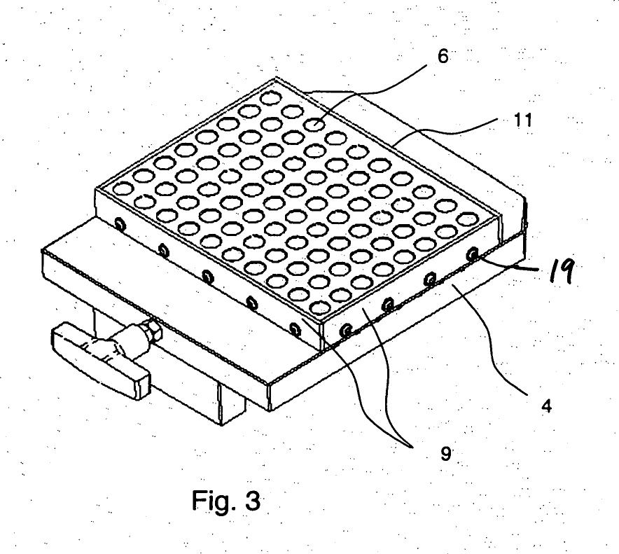

### SPECIFIC DESCRIPTION

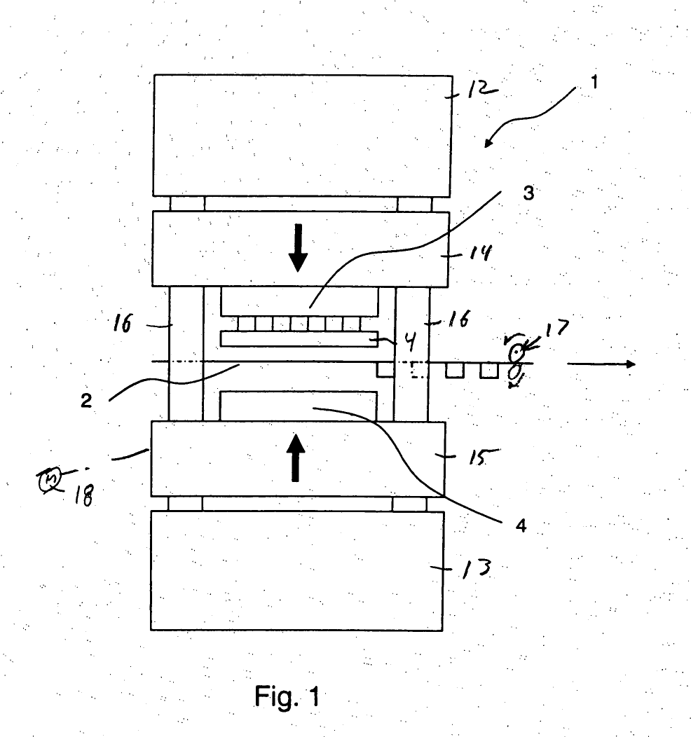

As seen in FIG. 1 a press 1 according to the invention has a rigid frame comprising upper and lower stationary elements 12 and 13 flanking vertically shiftable upper and lower traverses 14 and 15 and interconnected fixedly by vertical guide rods 16 on which the traverses 14 and 15 slide. A drive illustrated schematically at 18 vertically shifts the upper and/or lower traverses 14 and 15 vertically toward and away from each other and may correspond to the system described in commonly owned U.S. patent application Ser. No. 11/352,450 filed 10 Feb. 2006, which is incorporated herein by reference.

Such a press is used to form a planar foil 2, typically of plastic, with an array of upwardly open blisters or pockets that may be filled with a product, e.g. pills, and then covered with a flat cover foil that is welded down atop the foil 2 between the pockets. Thus the press 1 of this invention is at the upstream end of the production line producing the packages, followed by a pocket-filling station, a cover-affixing station, and a cutting station.

The upper tool holder or traverse 14 carries an upper shaping tool or platen 3 and the lower holder or traverse 15 carries a lower shaping tool or platen 4, both of cast aluminum. In the illustrated embodiment, the upper platen 3 has an array of downwardly projecting cylindrical punches 5, and the lower platen 4 in an array corresponding to that of the punches 5 has a corresponding number of upwardly open cylindrical recesses or seats 6. The upper platen 3 is associated with a hold-down device, here another aluminum plate 7, to which pressure is applied by compression springs 8 bearing upward on the upper platen 3. The punches 5 extend through complementary throughgoing cylindrical bores in the hold-down plate 7 and serve to guide it and maintain it parallel to the platen 3 and perpendicular to a vertical closing direction of the press 1. The platens 3 and 4 may be heated to aid deformation of the foil. 2 when it is thermoplastic.

The lower platen 4 has clamping bars 9 acting as support faces 11 for the hold-down device 7. These bars 9 can be made of plastic and due to their elasticity are able to compensate for manufacturing inaccuracies when bearing against the hold-down device 7. Here the clamping bars 9 are compressed by about 0.05 mm as a result of the prestressing force of the compression springs 8 when the hold-down device 7 bears on them, in the closed position of the press 1.

A planar and downwardly directed clamping face 10 of the hold-down device 7 first undergoes a glass bead blasting operation to prepare for a coating and then a hard coating is applied on the surface treated this way, which coating creates a planar surface having low roughness, for which particularly a ceramic coating is suited. Actuators are associated with the tool holders of the press 1 to mutually align the upper platen 3 and the lower platen 4.

As shown here, the bars 9 are secured by bolts 19 to side faces of the lower platen 4 and in fact their upper ends project slightly past the upper face of this platen 4.

We claim:

1. A press for shaping a workpiece sheet, the press comprising:
upper and lower platen holders displaceable vertically toward and away from each other between a closed and an open position;
respective upper and lower platens carried on the holders and vertically flanking the workpiece sheet extending horizontally between them;
a hold-down plate on one of the platens and having a substantially planar face turned toward the other platen; and
a plurality of bars on the other platen having edges directly engageable with the planar face of the hold-down plate.

2. The shaping press defined in claim 1 wherein the planar face is provided with a hard coating.

3. The shaping press defined in claim 2 wherein the planar face is glass-ball treated under the coating.

4. The shaping press defined in claim 2 wherein the coating is ceramic.

5. The shaping press defined in claim 4 wherein the coating has a roughness of about 2.7 μm.

6. The shaping press defined in claim 1 wherein the bars are plastic.

7. The shaping press defined in claim 6 wherein the hold-down plate is aluminum.

8. The shaping press defined in claim 1, further comprising
springs engaged between the hold-down plate and the upper platen permitting limited vertical movement of the hold-down plate relative to the upper platen.

9. The shaping press defined in claim 1 wherein the bars lower platen has side faces extending transversely of a closing direction of the platens and the bars are fixed to these side faces.

10. The shaping press defined in claim 1 wherein the press is provided with vertical guides along which the holders and platens are shiftable.

11. The shaping press defined in claim 1 wherein the upper platen is provided with an array of punches extending downward through the hold-down plate and the lower platen is formed inward of the bars with an array of upwardly open seat recesses in which the punches are engageable in the closed position.
